(19) United States
(12) Patent Application Publication
(10) Pub. No.: US 2016/0165367 A1
(43) Pub. Date: Jun. 9, 2016

(54) A RECHARGEABLE HEARING DEVICE AND A BATTERY CHARGER FOR CHARGING THE HEARING DEVICE

(71) Applicant: SONOVA AG, Stäfa (CH)

(72) Inventor: Andre Lucien Ochsenbein, Wolfhausen (CH)

(21) Appl. No.: 14/906,332

(22) PCT Filed: Jul. 22, 2013
(86) PCT No.: PCT/EP2013/065431

§ 371 Date: Jan. 20, 2016

(51) Int. Cl. H04R 25/00

(52) U.S. Cl. CPC H04R 25/556; H04R 25/602; H04R 2225/023; H04R 2225/33

(57) ABSTRACT

A hearing device to be worn at least partially within an ear canal includes a microphone, an electronics unit, a receiver and a rechargeable battery, which are contained in a housing formed by a shell to which a face plate is attached. The face plate features a docking connector for engaging with a battery charger, whereby the docking connector projects outwardly from the face plate. Furthermore, a battery charger featuring a docking port adapted to engage with the docking connector of the hearing device is given.

### TECHNICAL FIELD

The present invention relates to a hearing device powered by a rechargeable battery, in particular a hearing device to be worn at least partially within an ear canal. The present invention further pertains to a battery charger for charging such a hearing device.

### BACKGROUND OF THE INVENTION

Portable electronic devices are increasingly being powered by rechargeable batteries. This is also the case for miniature hearing devices adapted to be worn at an ear or at least partially within an ear canal of a user. Such hearing devices include ear phones, communication devices, hearing aids (also referred to as hearing prostheses or hearing instruments) for hard of hearing people or hearing enhancement devices for augmenting the hearing capability of normal hearing persons, as well as hearing protection devices designed to prevent noise-induced hearing loss. Due to the small size of such hearing devices the batteries employed therein are tiny and therefore often difficult to handle, e.g. when replacing a depleted battery with a new one, especially for elderly users with reduced dexterity. Hence, the use of rechargeable batteries which do not need to be removed from a device for recharging represent a considerable improvement for such users. Furthermore, such hearing devices are typically utilised for prolonged periods of time, e.g. during most of the day on a daily basis, so the batteries need to be replaced very often, for instance every few days. This puts a substantial financial burden on the users of such devices due to the considerable cost of the batteries required for operating them. Therefore, the use of rechargeable batteries substantially reduces the operating costs of such hearing devices.

In particular hearing devices to be worn at least partially within an ear canal profit from using a built-in rechargeable battery instead of a traditional single-use, disposable zinc air battery, because this relieves the user from having to perform the tedious task of replacing the very small, e.g. size 10A, batteries when they are empty. Rechargeable batteries are especially beneficial for hearing devices intended to be worn deeply within the ear canal, e.g. within the bony portion. Examples of such hearing devices are the Philips XP Peritympanic deep canal CIC aid, the Starkey Tympanette and SoundLens, the Songbird Flexfit disposable hearing aid, and Insound's Lyric extended wear hearing aid. U.S. Pat. No. 6,205,227 B1 also relates to a peritympanic hearing instrument, WO 00/32009 A2 relates to a semi-permanent canal hearing device, and WO 00/76271 A1 relates to an extended wear canal hearing device. Such deep-fitted hearing devices are typically worn constantly over a prolonged period of time, e.g. many days up to weeks, without being removed since their insertion and extraction is a tricky and quite awkward procedure sometimes requiring the help of a specialist. Consequently, the battery needs to be sealed into the hearing device in order to prevent sweat from disrupting battery operation. Hence, replacement of the battery is not possible and so it has to be rechargeable. Since the battery is built into the hearing device there is no need for a battery door to remove the battery, which helps to minimise the size of the hearing device.

For recharging the battery the hearing device needs to be linked to a battery charger. U.S. Pat. No. 6,658,124 B1 describes a contact-free scheme using an inductive charging system for hearing devices. However, inductive charging suffers from a low degree of efficiency and has the disadvantage of requiring a charging coil within the hearing device. Alternatively, electrical contacts are provided at the housing of the hearing device. WO 93/18629 A1 describes a charging device for custom shaped rechargeable hearing prostheses with electrical contacts integrated in the housing in the form of two conducting surfaces. The charging device provides cavities for receiving the hearing prostheses, the cavities being formed according to the shape of the prostheses and having conductive terminals which are arranged so that electrical contact is established with the conducting surfaces when the hearing prostheses are inserted into the cavities. The disadvantage of this solution is that the cavities in the charging device have to be adapted according to the custom shape of the user's hearing prostheses. US 2008/0118093 A1 describes a contact element that is resiliently mounted at a hearing device and can be pressed onto a charging contact of an external charging device during charging under application of a positive force. The contact element is located in a first position during normal operation of the hearing device and is moved into a second position for charging. A magnetic element in the charging device can be used to hold the hearing device in order to press the contact element of the hearing device against the charging contact of the charging device. Alternatively, the charging device exhibits a receptacle adapted to the shape of the hearing device, and the contact element of the hearing device is pressed against the charging contact of the charging device when the hearing device is clamped into the receptacle by means of a clamp. US 2009/0067652 A1 discloses a hearing device with at least one contact means, which can be flush with the hearing device housing during normal operation, and contacts a battery charging unit when in an extended or folded-out position during charging. An in-the-ear hearing device with a front face can be docked onto a receiving apparatus of the battery charging unit. The hearing device is thereby mechanically fixed in the external unit at the front face. With these prior art solutions where charging contacts are used for custom hearing devices, which are individually shaped according to the shape of the ear canal of the hearing device user, a precise positioning of the charging contacts and a secure connection of the charging contacts to a standardised battery charger is difficult to achieve.

### SUMMARY OF THE INVENTION

It is an object of the present invention to overcome the disadvantages of the prior art solutions and to provide a custom-shaped rechargeable hearing device, which can be easily and reliably connected with a battery charger. This object is reached by the hearing device according to claim 1.

It is a further object of the present invention to provide a battery charger for charging such a hearing device. Such a battery charger is specified in claim 14.

Specific embodiments of the present invention are provided in the dependent claims.

The present invention is first directed to a hearing device to be worn at least partially within an ear canal, comprising a microphone, an electronics unit, a receiver and a rechargeable battery, which are contained in a housing formed by a shell to which a face plate is attached, characterised in that the faceplate features a docking connector for engaging with a battery charger, the docking connector projecting outwardly from the faceplate.

In an embodiment of the hearing device the docking connector features one or more electrical contacts.

In a further embodiment of the hearing device the docking connector is tubular-shaped.

In a further embodiment of the hearing device the docking connector comprises a hollow cylinder.

In a further embodiment of the hearing device the hollow cylinder features a flange.

In a further embodiment of the hearing device the hollow cylinder features one or more radially and outwardly protruding pins, cams, rails, external ridges, locking tabs or locking fingers, in particular an opposing pair thereof.

In a further embodiment of the hearing device the docking connector features snap catches.

In a further embodiment of the hearing device the docking connector forms part of a bayonet mount.

In a further embodiment of the hearing device the docking connector forms part of a snap link, a twist-on link or screw connection.

In a further embodiment of the hearing device the face plate is non-detachably attached to the shell and the rechargeable battery is not removable from the housing.

In a further embodiment of the hearing device the docking connector comprises a blind hole or a pocket extending into the face plate.

In a further embodiment of the hearing device at least one of the one or more electrical contacts is arranged in a bottom surface of the blind hole or the pocket.

In a further embodiment of the hearing device the at least one of the one or more electrical contacts is located in a bore or a recess.

In a further embodiment of the hearing device a microphone sound port and/or a vent opening is arranged in a bottom surface of the blind hole or the pocket.

In a further embodiment of the hearing device the docking connector comprises a cap adapted to cover the blind hole or pocket, in particular a protective cap.

In a further embodiment of the hearing device the cap is partly made of an air-permeable material, and is in particularly adapted to act as a microphone protection element.

In a further embodiment of the hearing device the cap is snap or twist-on mountable on the docking connector.

In a further embodiment of the hearing device the hearing device is a completely-in-canal hearing device, more particularly a deep-fitting hearing device intended to be worn in a bony portion of the ear canal, even more particularly an extended wear hearing device.

In a further embodiment of the hearing device the docking connector is adapted to engage with a holding means of a battery charger.

The present invention is further directed to a battery charger featuring a docking port adapted to engage with the docking connector of the proposed hearing device.

In an embodiment of the battery charger the docking port is formed to embrace the docking connector of the proposed hearing device.

In a further embodiment of the battery charger the docking port comprises one or more, in particular two, movable latches.

In a further embodiment of the battery charger the one or more movable latches are spring-loaded.

In a further embodiment of the battery charger the docking port comprises one or more charging pins.

In a further embodiment of the battery charger the one or more charging pins are spring-mounted.

It is pointed out that combinations of the above-mentioned embodiments give rise to even further, more specific embodiments according to the present invention.

### BRIEF DESCRIPTION OF THE DRAWINGS

The present invention is further explained below by means of non-limiting exemplary embodiments and with reference to the accompanying drawings, which show:

FIG. 1 an exemplary face plate with a docking connector having two opposite facing ridges according to the present invention;

FIG. 2 a docking connector of a hearing device engaged with a docking port of a battery charger according to the present invention illustrating two movable latches of the docking port; and

FIG. 3 a docking connector of a hearing device engaged with a docking port of a battery charger according to the present invention especially illustrating spring-mounted charging pins of the battery charger and corresponding electrical contacts of the hearing device.

In the figures, like reference signs refer to like parts.

### DETAILED DESCRIPTION OF THE INVENTION

The hearing device 1 referred to in the following is a hearing device intended to be worn at least partly within an ear canal of a user of the hearing device, such as an in-the-ear (ITE) or a completely-in-canal (CIC) hearing device. It can especially be an extended wear hearing device for being worn deeply within the ear canal, for instance within the bony portion of the ear canal for a prolonged period of time, e.g. at least a day. Such hearing devices comprise a microphone, an electronics unit, a receiver and a power source such as a rechargeable battery, which are contained in a housing. The housing typically comprises a custom shell and a standardised face plate, which is adapted to fit to the custom shell. The face plate is usually glued to the shell or attached thereto in some other non-detachable manner, meaning that for example the rechargeable battery is not removable from the housing once the hearing device is assembled without destroying it.

FIG. 1 shows a face plate 3 of a hearing device 1 according to the present invention. The face plate 3 features a docking connector 4 projecting outwardly from the face plate 3. A shell 2 of the hearing device 1 (not shown in FIG. 1) would thus be attached to the bottom side of the face plate 3, i.e. the side opposite to the docking connector 4. The shell 2 is custom-shaped according to the individual shape of the ear canal of the user of the hearing device 1. The face plate 3 is cut to fit the custom-shaped shell 2 during manufacturing of the hearing device 1. Therefore, the docking connector 4 should be centrally located on the face plate 3, in order to ensure that the face plate 3 is not affected by the cutting process and remains intact. In the present embodiment the docking connector 4 is tubular-shaped and comprises a hollow cylinder 7. The hollow cylinder 7 features two radially and outwardly protruding ridges 8, 8′ at its upper rim. These two ridges 8, 8′ are arranged at opposite sides of the opening of the hollow cylinder 7. Alternatively, pins, cams, rails, locking tabs or locking fingers can be employed instead of the ridges 8, 8′. A microphone opening 11 is located on the face plate 3 so as to allow sound to be picked up by a microphone (not shown) arrange beneath the microphone opening 11. Furthermore, a vent opening 12 is also located on the face plate 3, which forms the outer end of a vent longitudinally traversing the hearing device 1, to provide ventilation of the inner portion of the ear drum when the hearing device 1 is being worn. Within the hollow cylinder 7 there is a hole 9 wherein for instance a contact pin 6, 6′ is arranged. The contact pin 6, 6′ can alternatively be arranged beneath the face plate 3 and located behind the hole 9. As a further alternative the microphone opening 11 and/or the vent opening 12 can also be located within the hollow cylinder 7. By arranging a cap (not shown) over the opening of the hollow cylinder 7 the microphone opening 11 and the vent opening 12 can be protected against being contaminated and becoming clogged, e.g. by ear wax or sweat. The cap could comprise a wax protection element allowing air (and thus sound) to pass but holding back debris. The cap could for instance be attached to the hollow cylinder by means of a snap link, a twist-on link or screw connection or a bayonet mount.

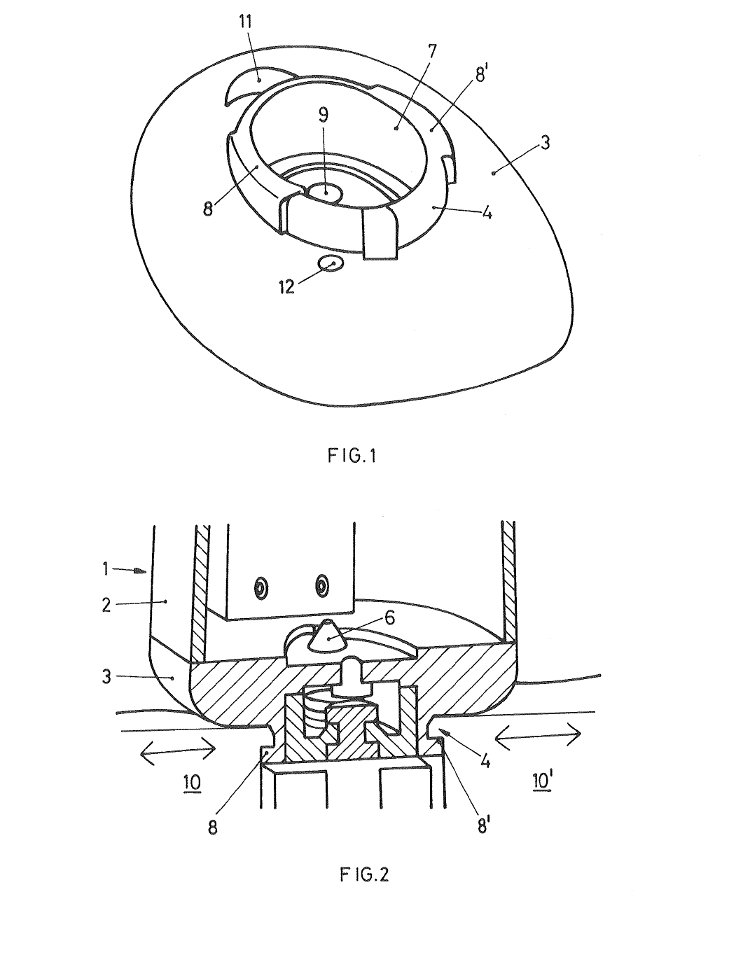

FIG. 2 shows a hearing device 1 with the face plate 3 of FIG. 1 engaged with a battery charger 5. The docking connector 4 on the face plate 3 of the hearing device 1 is held by two moveable latches 10 and 10′ located opposite to one another at a docking port of the battery charger 5. The two latches 10 and 10′, respectively, are adapted to clasp the docking connector 4 of the face plate 3 at the two ridges 8 and 8′, respectively, of the docking connector 4. The moveable latches 10, 10′ are spring-loaded and biased towards clasping the ridges 8, 8′. The hearing device 1 can be disengaged from the battery charger 5 by applying force to the latches directed against the biasing force provided by the springs associated with the latches 10, 10′. In this way the latches 10, 10′ are withdrawn from the ridges 8, 8′ and the hearing device 1 is freed to dislodge for the battery charger 5.

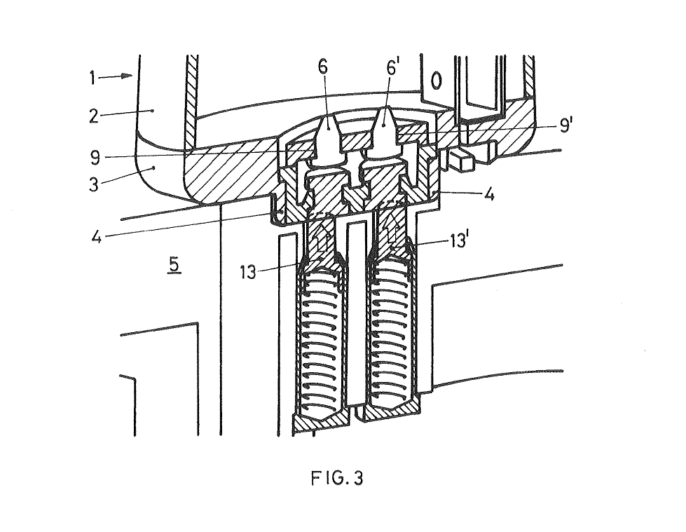

FIG. 3 shows a different view of the hearing device 1 engaged with a battery charger 5 rotated by 90° relative to the view of FIG. 2. Here it can be seen that two spring-mounted charging pins 13, 13′ located in the docking port of the battery charger 5 are forced against corresponding electrical contact pins 6, 6′ arranged in holes 9, 9′ located in the docking connector 4 of the face plate 3.

What is claimed is:

1. A hearing device (1) to be worn at least partially within an ear canal, comprising a microphone, an electronics unit, a receiver and a rechargeable battery, which are contained in a housing formed by a shell (2) to which a face plate (3) is attached, characterised in that the face plate (3) features a docking connector (4) for engaging with a battery charger (5), the docking connector (4) projecting outwardly from the face plate (3).

2. The hearing device (1) of claim 1, wherein the docking connector (4) features one or more electrical contacts (6, 6′).

3. The hearing device (1) of claim 1, wherein the docking connector (4) is tubular-shaped.

4. The hearing device (1) of claim 1, wherein the docking connector (4) comprises a hollow cylinder (7).

5. The hearing device (1) of claim 4, wherein the hollow cylinder (7) features a flange.

6. The hearing device (1) of claim, wherein the hollow cylinder (7) features one or more radially and outwardly protruding pins, cams, rails, ridges (8, 8′), locking tabs or locking fingers, in particular an opposing pair thereof.

7. The hearing device (1) of claim 1, wherein the docking connector (4) features snap catches.

8. The hearing device (1) of claim 1, wherein the docking connector (4) forms part of a bayonet mount.

9. The hearing device (1) of claim 1, wherein the docking connector (4) forms part of a snap link, a twist-on link or screw connection.

10. The hearing device (1) of claim 1, wherein the face plate (3) is non-detachably attached to the shell (2) and the rechargeable battery is not removable from the housing.

11. The hearing device (1) of claim 1, wherein the docking connector (4) features a hole (9), a blind hole or a pocket extending into the face plate (3).

12. The hearing device (1) of claim 2, wherein at least one of the one or more electrical contacts (6, 6′) is arranged at or in the hole (9).

13. The hearing device (1) of claim 1, wherein the hearing device (1) is a completely-in-canal hearing device, more particularly a deep-fitting hearing device intended to be worn in a bony portion of the ear canal, even more particularly an extended wear hearing device.

14. A battery charger (5) featuring a docking port adapted to engage with the docking connector (4) of the hearing device (1) of claim 1.

15. The battery charger (5) of claim 14, wherein the docking port is formed to embrace the docking connector (4) of the hearing device (1).

16. The battery charger (5) of claim 14, wherein the docking port comprises one or more, in particular two, movable latches (10, 10′).

17. The battery charger (5) of claim 14, wherein the one or more movable latches (10, 10′) are spring-loaded.

18. The battery charger (5) of claim 14, wherein the docking port comprises one or more charging pins (13, 13′).

19. The battery charger (5) of claim 14, wherein the one or more charging pins (13, 13′) are spring-mounted.
